(19) United States
(12) Patent Application Publication
(10) Pub. No.: US 2022/0332328 A1
(43) Pub. Date: Oct. 20, 2022

(54) DEVICE FOR DETERMINING A LENGTH OF A VEHICLE COMBINATION

(71) Applicant: ZF Friedrichshafen AG, Friedrichshafen (DE)

(72) Inventors: Andreas WEBER, Stuttgart (DE); Matthias RÜBER, Oberteuringen (DE)

(73) Assignee: ZF Friedrichshafen AG, Friedrichshafen (DE)

(21) Appl. No.: 17/717,946

(22) Filed: Apr. 11, 2022

(30) Foreign Application Priority Data
Apr. 14, 2021 (DE) 10 2021 203 659.7

(51) Int. Cl. B60W 40/12; G07C 5/04

(52) U.S. Cl. CPC B60W 40/12; G07C 5/04; B60W 2530/201; B60W 2530/205

(57) ABSTRACT

A device for determining the length of a vehicle combination comprises an input interface for receiving current driving dynamics data, in particular information regarding the current travel path of the towing vehicle, and a comparison unit for comparing the received current driving dynamics data with stored patterns of driving dynamics data that are typical for driving with a trailer of known dimensions, and an evaluation unit, which derives the length of the vehicle combination from the differences between the current driving dynamics data and the stored typical patterns of driving dynamics data. The device can use the sensors in the towing vehicle for obtaining the current driving dynamics data. Without additional hardware, a length of the vehicle combination, e.g. the length of a trailer connected to a towing vehicle, can be determined in this manner.

The present invention relates to a device, a system, and a method for determining the length of a vehicle combination that comprises a towing vehicle and at least one trailer.

Driving a towing vehicle with a trailer is substantially different than driving just the towing vehicle, without the trailer. This is the case with passenger vehicles as well as large trucks. As the size and weight of the trailer increases, the driving behavior of the towing vehicle differs more significantly from that when not towing a trailer. In particular, the trailer has a significant effect on the path that the vehicle combination takes when travelling through curves.

The overall length of the towing vehicle with the trailer, or the length of the trailer itself, which determines the overall length of the combination if the length of the towing vehicle is fixed, is of decisive importance for the driving behavior of the vehicle combination.

When travelling in a straight line, the trailer follows the path of the towing vehicle. In curves, or when maneuvering, the trailer follows a different path. In particular when taking a tight turn there is a greater challenge because the trailer will always travel along a curve with a smaller radius than the towing vehicle. When making a right turn, the towing vehicle must stay as far left as possible, and when making a left turn, it must stay as far to the right as possible. In particular when towing a longer trailer it may be necessary to drive over the island in roundabout in order to be able to take a sharp turn. With a smaller radius turn, the centrifugal forces acting on the towing vehicle from the trailer via the trailer hitch are greater. In particular when changing lanes, the towing vehicle and trailer may sway or even tilt.

The towing vehicle and trailer are normally connected to one another not only mechanically, but also electrically, via a flexible cable, in order that the trailer can be supplied with electricity for the mandatory lighting. Depending on the nature of the electrical connection, the control electronics in the towing vehicle can obtain information regarding whether or not a trailer is (electrically) connected to it. With modern passenger vehicles, the driving stability program is set to a trailer mode if a trailer has been detected. The control electronics for the towing vehicle normally does not receive any information, however, regarding the length of the trailer, or the overall length of the combination as a result of the trailer connected to the towing vehicle.

For more refined driver assistance systems it would be desirable if the system automatically obtained information regarding the trailer, in particular its length, ideally automatically and independently of the obligatory, but not always reliable, cable connection between the trailer and the towing vehicle.

DE 10 2019 206 625 A1 describes a method for determining a length of a vehicle in a vehicle combination by determining a first distance between a position-detecting sensor unit for a first vehicle and a position-detecting sensor unit for a second vehicle, detecting a second spatial distance between the first vehicle and the second vehicle by means of a distance-detecting sensor unit on a vehicle, and determining the length of the first vehicle on the basis of the first and second spatial distances that have been determined. All of the vehicles in the vehicle combination must therefore be equipped with special sensor units and special control units for this.

The fundamental technological problem addressed by the invention is to determine the length of a vehicle combination without additional measurement technology or other hardware on either the towing vehicle or the trailer, and to provide this information to the control electronics in the towing vehicle.

The invention is based on the idea of determining the length of the trailer, or the overall length of the vehicle combination, as precisely as possible from just the driving behavior, in particular the steering movements or steering behavior of the towing vehicle.

This object is achieved by a device according to the first claim.

The device according to the invention comprises an input interface for receiving current driving dynamics data from a sensor on the towing vehicle while driving with a trailer, a comparison unit for comparing the current driving dynamics data that have been received with stored driving dynamics data, and an evaluation unit for deriving the length of the vehicle combination, in particular that of the trailer, from differences between the current driving dynamics data and the stored driving dynamics data. Because the driving behavior of the towing vehicle changes significantly when one or more trailers are connected to it, the driving dynamics data when driving with a trailer differ significantly from the driving dynamics data that are obtained when driving the same towing vehicle without a trailer. Particularly instructive driving dynamics data are the steering movements and steering angles, the yaw rates, as well as the driving speeds, in particular in tight curves, and the vehicle accelerations, that are obtained. If the comparison unit does not detect any differences, then it is apparent that no trailer is attached to the towing vehicle, and the length of the trailer that is derived therefrom is therefore zero, and the length of the “vehicle combination” corresponds to the length of just the towing vehicle.

The comparison unit preferably compares the current driving dynamics data for the towing vehicle with a stored pattern of driving dynamics data, which are typical for driving with a trailer of known dimensions, and the evaluation unit is then able to determine whether the current driving dynamics data correspond to a typical pattern that has been stored. The length of the vehicle combination, or that of the trailer, is then the length belonging to the typical pattern. With a larger number of typical patterns of driving dynamics data that are stored for trailers with known dimensions, it is possible to more precisely identify a specific trailer using pattern recognition (pattern matching), and determine the current length of the vehicle combination from this.

In a preferred embodiment of the device according to the invention, information regarding the current travel path of the towing vehicle is received through the input interface. In modern vehicles with advanced electronic driver assistance systems (ADAS) the steering movements or steering angles are detected continuously. Cameras, radar systems or lidar systems can also be used to detect the travel path of the towing vehicle and compare this with the course of the street. The comparison of the current travel path with a stored travel path that is typical for driving with a specific trailer of a known length is particularly informative if a length of the vehicle combination, in particular the length of the trailer connected to the towing vehicle, is to be determined or estimated.

If the comparison unit and/or evaluation unit has machine learning capabilities, the device according to the invention continuously learns how to better estimate the length of the vehicle combination over the course of being driven more frequently in the trailer mode from the driving dynamics data, in particular the various driving paths.

The great advantage of the device according to the invention is that in modern vehicles that are equipped with driver assistance systems, or even with systems for autonomous or semiautonomous driving, the necessary hardware as well as most of the necessary software for detecting and evaluating driving dynamics data, in particular information regarding the travel path, are already present, such that no additional measurement technology or hardware are necessary for determining the length of the vehicle combination, or the trailer, and to then be able to adjust the control electronics in the towing vehicle to the configuration of the vehicle combination.

The object is also achieved with a system according to claim 6, which comprises a sensor for detecting driving dynamics data for the towing vehicle while it is being driven, and a device that has the features described above.

The sensor can be a sensor for detecting the yaw rate, steering movement, steering angle, driving speed, or vehicle acceleration, in particular. A combination of various sensors can also be used. By way of example, radar sensors located at the front, rear and sides of the towing vehicle, can work together with a front-end camera and, optionally, side cameras. It is conceivable, for example, that the front-end camera detects the boundaries of the roadway and compares these with images from the side cameras, in order to recognize conspicuous deviations in the expected normal travel path for the towing vehicle, and to identify those deviating travel paths that are typical for the towing mode, in order to the derive the length of the vehicle combination therefrom. Unusually strong steering movements and large steering angles while travelling through tight curves or roundabouts also lead to the conclusion that a trailer is connected to the towing vehicle, and potentially enable a determination of the (approximate) length of the trailer.

The object is also achieved with a method that comprises the steps listed in claim 9: receiving current driving dynamics data, comparing these with stored driving dynamics data, and deriving the length of the vehicle combination from the differences obtained in the comparison. The current travel path is preferably compared with stored travel paths that are typical for driving with a trailer in order to determine the corresponding length of the vehicle combination therefrom.

Further aspects of the invention relate to a computer program that contains program code for executing the steps of the method according to the invention when the program code is executed on a computer, and a memory on which a program is stored, which results in the method described herein being executed when the program is executed on a computer.

Preferred embodiments of the invention are described in the dependent claims. It is to be understood that the features specified above and explained below can be used not only in the respective given combinations, but also in other combinations or in and of themselves, without abandoning the framework of the present invention. In particular, the method and the computer program can be designed such that they can be executed by the embodiments of the device or system described in the dependent claims.

Exemplary embodiments of the invention shall be explained below in reference to the drawings. Therein:

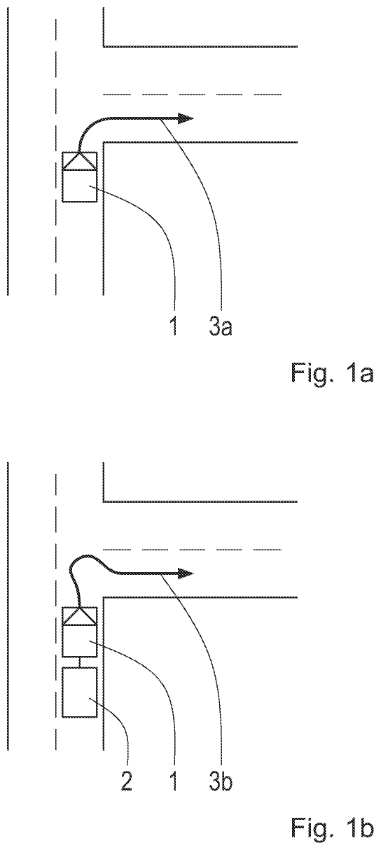

FIG. 1a shows, schematically, the normal travel path of a towing vehicle when making a turn;

FIG. 1b shows a different, typical travel path of the same towing vehicle, when towing a trailer;

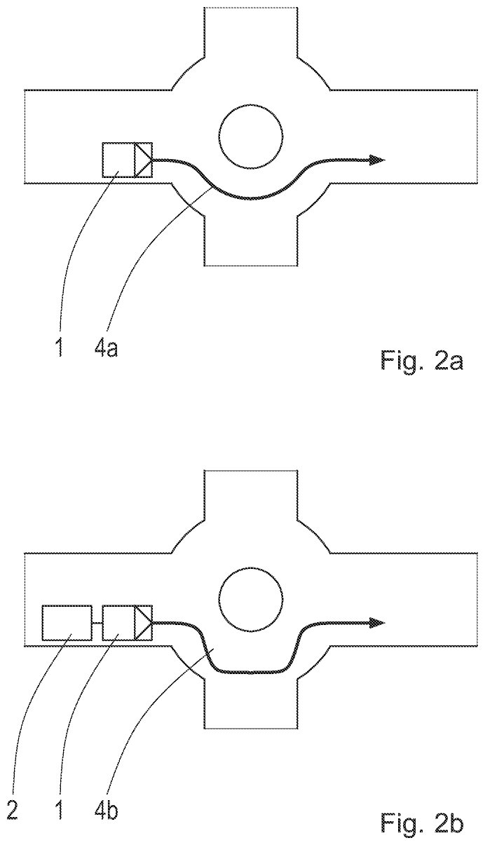

FIG. 2a shows, schematically, the normal travel path of a towing vehicle when travelling through a roundabout;

FIG. 2b shows a different, typical travel path for the same towing vehicle, when towing a trailer;

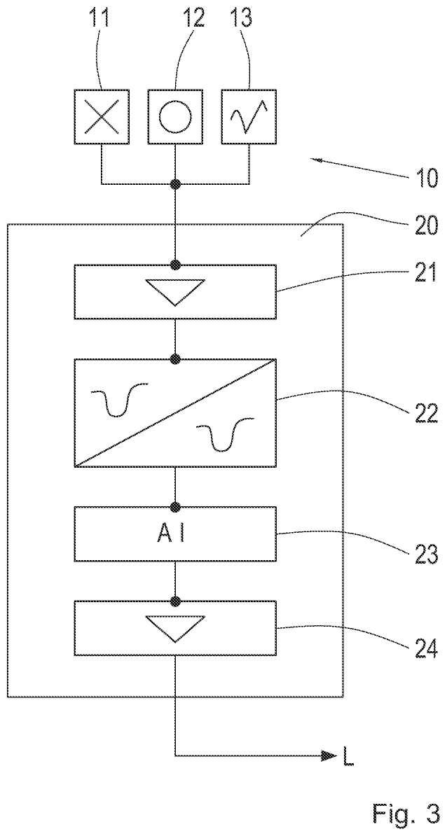

FIG. 3 shows a system that has a device for determining the length of a vehicle combination, in an image illustrating the basic principle of the system.

FIG. 1a illustrates how a towing vehicle 1 without a trailer makes a right-hand turn into a side street. The travel path forms a quarter circle, which then transitions into a straight line at the end thereof that is parallel to the roadway.

FIG. 1b illustrates how the same towing vehicle 1 travels through the same turn when a trailer 2 is connected to it. The travel path 3b differs significantly from the travel path 3a that would be travelled by the towing vehicle 1 without the trailer (FIG. 1a) in that the towing vehicle 1 first moves toward the left prior to reaching the intersection, in order to subsequently steer hard to the right. The travel path 3b therefore first takes approximately an eighth of a circle toward the left, and then a subsequent quarter circle with a smaller radius toward the right. In the end, the towing vehicle 1 turns in the other direction, i.e. to the left, so that the towing vehicle 1 and trailer 2 are again aligned and parallel to the roadway at the end of the maneuver.

The travel path 3b is typical for a vehicle combination comprising a towing vehicle 1 and a trailer 2. The longer the trailer 2, the more the towing vehicle 1 must shift to the left prior to turning right, such that the towing vehicle 1 must then make a tighter right hand turn. This is the only way to ensure that the trailer 2 does not cut over the corner, because it will always travel over a smaller radius than the towing vehicle. The travel path 3b for the vehicle combination makes use of the entire width of the available roadway.

FIGS. 2a and 2b illustrate the different travel paths (4a, 4b) when passing through a roundabout, first with just the towing vehicle (FIG. 2a) and then with the trailer 2 (FIG. 2b). When entering the roundabout, the towing vehicle 1 with the trailer 2 travels further in a straight line, and then steers hard to the right. The trailer 2 travels though a smaller radius here as well, so that it does not get caught on the corner. Prior to exiting the roundabout, the towing vehicle 1 must first get as far inside as possible, to be able to subsequently turn nearly ninety degrees to the right in order to be able to exit the roundabout. The travel path 4b is typical for passing through a roundabout with a trailer 2, and differs strongly from the travel path 4a, which the towing vehicle 1 would travel along without a trailer.

Typical travel paths for left hand turns or other turning angles are obtained in a similar manner. In all cases, the travel path of the towing vehicle 1 when it is connected to a trailer 2 differs significantly from that of the vehicle 1 when it is not connected to a trailer. The pattern for the travel path is therefore substantially dependent on the length of the vehicle combination, in which, if the length of the towing vehicle is fixed, the length of the trailer, or numerous trailers if more than one is being towed, is decisive.

The fundamental structure of a system 10 for determining the length of a vehicle combination, e.g. the overall length of the combination comprising a towing vehicle 1 and a trailer 2, is illustrated in FIG. 3.

The system 10 comprises a steering angle sensor 11, an acceleration sensor 12, and a yaw rate sensor 13, which are components of the advanced driver assistance system (ADAS) in the towing vehicle 1 shown in FIG. 1a in this case.

The system 10 also comprises a device 20 that has an input interface 21, a comparison unit 22, an evaluation unit 23, and an output interface 24. The device 20 also belongs to the towing vehicle 1, and is integrated in this case, by way of example, in the advanced driver assistance system.

The input interface 21 receives current driving dynamics data from the steering angle sensor 11, the acceleration sensor 12, and the yaw rate sensor 13 in the towing vehicle 1. In particular, the input interface 21 receives information regarding the current travel path of the towing vehicle 1, i.e. the travel path 4b of the towing vehicle 1 when passing through the roundabout with a trailer 2, as shown in FIG. 2b. Typical travel paths for driving with trailers of known lengths are stored in the comparison unit 22. This allows the comparison unit 22 to compare the current travel path (4b in FIG. 2b) with the stored, typical travel paths. This comparison takes place according to the principle of pattern recognition (pattern matching). If the evaluation unit 23 recognizes that the current travel path corresponds to a stored, typical travel path, the evaluation unit 23 determines a length L belonging to the typical travel path, which is either the overall length of the vehicle combination, or the length of just the trailer 2, depending on the definition. The determined length L is output by the output interface 24, and sent to the advanced driver assistance system in the towing vehicle 1, so that the driving program can be adjusted accordingly.

The invention has been comprehensively described and explained in reference to the drawings in this description. The description and explanation are to be understood as an example, and not as limiting. The invention is not limited to the embodiments disclosed herein. Other embodiments or variations can be derived by the person skilled in the art in the use of the present invention, as well as through a more thorough analysis of the drawings, the disclosure, and the following claims.

The words “comprising” and “with” in the claims do not exclude the presence of other elements or steps. The indefinite articles “a” or “an” do not exclude the presence of a plurality. A single element or single unit can execute the functions of numerous units specified in the claims. An element, unit, interface, device, and system may be implemented partially or entirely in hardware and/or software. Simply specifying some measures in numerous different dependent claims is not to be understood to mean that a combination of these measures cannot likewise be used advantageously. A computer program can be stored/distributed on a non-volatile data medium, e.g. an optical memory or a solid state drive (SSD). A computer program can be distributed with hardware and/or as part of hardware, e.g. by means of the internet or a hard-wired or wireless communication system. Reference symbols in the claims are not to be understood as limiting.

### REFERENCE SYMBOLS

1 towing vehicle
2 trailer
3a, 3b travel path (turning)
4a, 4b travel path (roundabout)
10 system
11 steering angle sensor
12 acceleration sensor
13 yaw rate sensor
20 device
21 input interface
22 comparison unit
23 evaluation unit
24 output interface

1. A device for determining the length of a vehicle combination comprising a towing vehicle and a trailer, which has:
an input interface configured to receive current driving dynamics data from sensors in the towing vehicle while driving with a trailer;
a comparison unit configured to compare the current driving dynamics data that have been received with stored driving dynamics data; and
an evaluation unit configured to derive the length of the vehicle combination from the differences between the current driving dynamics data and the stored driving dynamics data.

2. The device according to claim 1, wherein
the comparison unit is configured to compare the current driving dynamics data with a stored pattern of driving dynamics data that is typical for driving with a trailer of a known length, and
wherein the evaluation unit is configured to recognize a typical pattern of driving dynamics data corresponding to the current driving dynamics data, and to determine the length of the vehicle combination belonging to the typical pattern.

3. The device according to claim 1, wherein
the input interface is configured to receive information regarding the current travel path of the towing vehicle,
the comparison unit is configured to compare the current travel path with a stored travel path that is typical for driving with a trailer of a known length, and
the evaluation unit is configured to recognize a typical travel path corresponding to the current travel path, and to determine the length of the vehicle combination belonging to the typical travel path.

4. The device according to claim 3, wherein the output unit is configured to output the length of the vehicle combination belonging to the recognized typical travel path.

5. The device according to claim 1, wherein at least one of the comparison unit or the evaluation unit are configured to perform machine learning.

6. A system for determining the length of a vehicle combination, comprising a towing vehicle and a trailer, comprising:
a sensor configured to obtain driving dynamics data for the towing vehicle while it is being driven; and
the device according to claim 1.

7. The system according to claim 6, wherein the sensor is configured to obtain information regarding the current travel path of the towing vehicle.

8. A vehicle comprising the system according to claim 7.

9. A method for determining a length of a vehicle combination, comprising a towing vehicle and a trailer, the method comprising:
receiving current driving dynamics data from a sensor in the towing vehicle while it is being driven;
comparing the current driving dynamics data with stored driving dynamics data; and
deriving the length of the vehicle combination from the differences between the current driving dynamics data and the stored driving dynamics data.

10. The method according to claim 9, wherein
the driving dynamics data contain information regarding the current travel path of the towing vehicle,
wherein the method further comprises:
comparing the current travel path with a stored travel path that is typical for driving with a trailer of a known length; and
determining and outputting a length of the vehicle combination belonging to the recognized typical travel path.

11. A non-transitory computer readable medium having stored thereon program code that, when executed on a computer, cause the computer to perform a method comprising:
receiving current driving dynamics data from a sensor in the towing vehicle while it is being driven;
comparing the current driving dynamics data with stored driving dynamics data; and
deriving the length of the vehicle combination from the differences between the current driving dynamics data and the stored driving dynamics data.

12. The non-transitory computer readable medium according to claim 9, wherein
the driving dynamics data contain information regarding the current travel path of the towing vehicle,
wherein the method further comprises:
comparing the current travel path with a stored travel path that is typical for driving with a trailer of a known length; and
determining and outputting a length of the vehicle combination belonging to the recognized typical travel path.
